(19) United States
(12) Patent Application Publication
(10) Pub. No.: US 2005/0276897 A1
(43) Pub. Date: Dec. 15, 2005

(54) Ultra-dry calcium carbonate

(75) Inventors: Christoph Nover, Rheinberg (DE); Helmut Dillenburg, Rheinberg (DE)

Correspondence Address: CROWELL & MORING LLP;INTELLECTUAL PROPERTY GROUP, P.O. BOX 14300, WASHINGTON, DC, 20044-4300, US

(73) Assignee: Solvay Chemicals, Hannover (DE)

(21) Appl. No.: 11/149,296

(22) Filed: Jun. 10, 2005

Related U.S. Application Data
(63) Continuation of application No. PCT/EP03/13663, filed on Dec. 4, 2003.

(30) Foreign Application Priority Data
Dec. 11, 2002 (DE) 102 57 696.3

(51) Int. Cl. A23F 5/00

(52) U.S. Cl. 426/594

(57) ABSTRACT

Ultra-dry calcium carbonate particles, a method for drying calcium carbonate particles and also the use of the resulting dried calcium carbonate as a flow property regulating agent in sealing compounds or adhesive compositions. The calcium carbonate particles are dried with microwaves. The drying can take place in a continuous belt apparatus, a batch treatment apparatus or a rotary-tube apparatus, and calcium carbonate particles having a degree of dryness of 0 to 0.1% H₂O can be obtained.

### CROSS REFERENCE TO RELATED APPLICATIONS

This application is a continuation of international patent application no. PCT/EP2003/013663, filed Dec. 4, 2003, designating the United States of America, and published in German as WO 2004/042784 on Jun. 24, 2004, the entire disclosure of which is incorporated herein by reference. Priority is claimed based on Federal Republic of Germany patent application no. DE 102 57 696.3, filed Dec. 11, 2002.

### BACKGROUND OF THE INVENTION

The present invention relates to an ultra-dry calcium carbonate. Calcium carbonate is produced by reacting an aqueous calcium hydroxide suspension with CO₂ or a gas containing carbon dioxide or by intensive milling or grinding of natural calcium carbonate. The product is conventionally dewatered and dried in a known manner.

Calcium carbonate is used e.g. in the production of paper, dyes, sealing compounds, adhesives, polymers, printing inks, rubber etc. It is used as a functional filler with pigment properties.

The range of uses of calcium carbonate is constantly widening due to its beneficial application properties. The process technology for the production of the calcium carbonate has in the meantime been modified to such an extent that different qualities of calcium carbonate can be produced depending on the intended use. Thus for example the structure of the particles can be varied. It is likewise possible to influence the residual moisture content in the end product by varying the drying conditions.

Usually, initial dewatering takes place by filtration or centrifuging, and then drying takes place with the aid of e.g. belt dryers, fluidized-bed dryers, crusher-dryers etc. The disadvantage of these methods is that the calcium carbonate is initially dried satisfactorily, but absorbs moisture again from the surrounding air during cooling. Depending on the fineness, or, more particularly on the specific surface area, this absorbed moisture content may be up to 3% by weight.

### SUMMARY OF THE INVENTION

It is an object of the invention to provide an improved, ultra-dry calcium carbonate product.

Another object of the invention is to provide a substantially completely dried calcium carbonate.

A further object of the invention is to provide an improved method of producing an ultra-dry calcium carbonate product.

These and other objects of the invention have been achieved by providing ultra-dry calcium carbonate particles having a degree of dryness of zero to 0.1% H₂O by weight.

In accordance with a further aspect of the invention, the objects are achieved by providing a method for producing ultra-dry calcium carbonate particles comprising subjecting calcium carbonate particles to microwave drying.

The present invention serves to dry completely and thus prepare for use conventionally produced calcium carbonate by subsequent treatment with microwaves.

In accordance with the present invention, precipitated calcium carbonate which has been dried e.g. by using a belt dryer, having a residual moisture content of 0.1 to 3% by weight, in special cases up to 80% by weight residual moisture content, is subsequently dried using microwaves.

Microwaves are electromagnetic waves of differing frequencies. Typical frequencies are 915 MHz and 2.45 GHz. In microwave treatment, heat is produced by the direct conversion of electromagnetic energy into kinetic energy of the molecules, i.e. in the moist product itself.

The conversion of electromagnetic energy into thermal energy takes place due to the electromagnetic properties of the materials to be heated. Whether and to what extent a material can be heated or dried by subjection to microwave radiation will depend on its molecular structure. Polar molecules, i.e. molecules with different charge ranges, e.g. water, can be heated effectively with microwaves. The polar molecule is caused to rotate by the high-frequency alternating field of the microwaves and in so doing converts the electromagnetic energy into heat. Since each molecule converts heat and the microwaves can penetrate deeply, depending on the material, the entire volume is heated up. This is an essential advantage over conventional heating or drying, in which the heat can penetrate the body only via the surface of the material.

The microwave energy converted upon complete absorption is:
Pᵥₑᵣₗ=2·π·f·E² εₒε′ᵣ tan·δ in W/m³ (1)

The depth of penetration is calculated as:

$$d = \frac{λ \sqrt{{ɛ}_{r}^{′}}}{2 {πɛ}_{r}^{″}} in cm \qquad ( 2 )$$

where:
f frequency in Hz,
εₒ, absolute dielectric constant (DC)=8.85×10⁻¹² As/Vm,
E amount of field strength of the electric alternating field in V/m,
ε =εₒ′ (εᵣ′-j εᵣ″), complex DC,
tanδ =εᵣ″/ε′ᵣ
δ dielectric loss angle in degrees, and
[symbol] ₒ wavelength in cm, [symbol] ₒ=C/f.

The temperature profile of the microwave heating is inverse to that of conventional heating. In microwave drying this inverse temperature profile is advantageous, since a high pressure builds up inside the material and forces the water to the surface. This water evaporates at the surface, which keeps it constant moist until the water has been virtually completely removed from the interior. Only after this does the surface also begin to dry.

Since the water, due to its polarity, absorbs a large if not the major portion of the microwave energy, a lesser conversion of energy takes place in those regions which are already dry so that the microwaves can penetrate more deeply into the material here. Thus it is possible to reduce very greatly the residual moisture content in the material, so that ultra-dry products can be produced.

It has been found that calcium carbonate particles which still have a residual moisture content of 0.1 to 3% H₂O by weight can be dried further by being subjected to microwave radiation. However, the suspension obtained from the precipitation or wet grinding or the filter cake obtained therefrom with residual moisture contents of over 80% or over 30% by weight can also be dried. The treatment can be carried out with any initial moisture content. Degrees of dryness of 0 to 0.1% by weight are achieved.

Different configurations of microwave drying plants are known. For large and lumpy materials, continuous belt plants or discontinuously operating batch vessel plants are used.

Powders or granules are preferably dried in microwave rotary-kiln plants. In this case, the material is passed through the heating zone in a rotating tube and in so doing is heated and dried by the microwaves.

The plant can be operated under vacuum, protective gas or under an air atmosphere. The bed height may be up to 20 cm, depending on the construction of the apparatus. A bed height of at most 10 cm has proved advantageous for calcium carbonate. Since only the residual moisture needs to be removed with this apparatus, no very high outputs are required. A few kW are sufficient, but 25 kW to over 100 kW can be used.

The calcium carbonate dried according to the invention can be used as an additive controlling the flow properties e.g. in sealing compounds or adhesives. The ultra-dry calcium carbonate can be used as an additive e.g. in 1-constituent or 2-constituent polyurethane sealing compounds, in silicone sealing compounds or modified silicone sealing compounds, in particular silyl-terminated polyether or methoxysilane (MS) polymer sealing compounds.

Advantages of microwave drying according to the invention include:
1. Belt plant drying is static drying, i.e. the product is not subjected to any mechanical stress.
2. A temperature gradient directed towards the surface, i.e. a temperature which is higher in the interior than on the surface and an associated higher partial pressure, which transports the liquid to be evaporated to the surface.
3. No drying-out of the surface layer, i.e. it remains permeable.
4. Upon evaporation in the interior, the liquid is guided to the outside by the pore structure. This results in a higher drying rate.
5. The partial pressure produced in the core by the microwaves speeds up the diffusion processes.
6. Rapid drying of moist products with low thermal conductivity.
7. Short drying times.

The following examples are intended to illustrate the invention in further detail without limiting its scope.

### EXAMPLES

### Example

Pre-dried CaCO₃ was dried in a continuous belt plant in a microwave channel (max. output: 6 kW/2450 MHz) with an active length of 2 m.
Belt coverage: 15 mm high
CaCO₃ with a residual moisture content of 0.37% H₂0 was used.

Tables 1 and 2 show the drying results under different conditions:

TABLE 1

| | Refer- | | | | | | |
|---|---|---|---|---|---|---|---|
| | ence | Examples 1-6 | | | | | |
| | sample | 1 | 2 | 3 | 4 | 5 | 6 |
| Belt speed | | 0.8 | 0.4 | 1 | 1 | 1.7 | 1.7 |
| m/min | | | | | | | |
| Output | | 1.5 | 1.5 | 1.5 | 1.3 | 1 | 1.7 |
| (kW) | | | | | | | |
| Through- | | 4.8 | 2.4 | 5.4 | 5.4 | 12 | 12 |
| put (kg/h) | | | | | | | |
| Residence | | 150 | 300 | 120 | 120 | 71 | 71 |
| time (s) | | | | | | | |
| Moisture | 0.37 | 0.00 | 0.00 | 0.02 | 0.04 | 0.05 | 0.06 |
| content | | | | | | | |
| (%) | | | | | | | |

TABLE 2

| | Reference | Examples 7-11 | | | |
|---|---|---|---|---|---|
| | sample | 7 | 8 | 9 | 10 |
| Belt speed m/min | | 2 | 2 | 3 | 4 |
| Output (kW) | | 5 | 5 | 5 | 5 |
| Throughput (kg/h) | | 60 | 60 | 90 | 120 |
| Residence time (s) | | 105 | 105 | 70 | 53 |
| Moisture content (%) | 0.37 | 0.01 | 0.0 | 0.11 | 0.26 |

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. Ultra-dry calcium carbonate having a degree of dryness of 0 to 0.1% H₂O.

2. A method for producing ultra-dry calcium carbonate particles, said method comprising subjecting calcium carbonate particles to microwave drying.

3. A method according to claim 2, wherein calcium carbonate particles having a residual moisture content of 0.1 to 3% H₂O are subjected to microwave radiation.

4. A method according to claim 2, wherein a calcium carbonate suspension obtained by precipitation or wet grinding or a filter cake obtained from filtration of such a suspension having a residual moisture content of up to more than 80% H₂O is dried by being subjected to microwave radiation.

5. A method according to claim 2, wherein the microwave drying is effected in a continuous belt apparatus, a batch vessel apparatus or a rotary-kiln apparatus.

6. A method according to claim 2, wherein the microwave drying is carried out under vacuum or under a protective gas atmosphere.

7. A method of controlling the flow properties of a sealing compound or adhesive composition, said method comprising incorporating in said composition an effective flow property regulating amount of ultra-dry calcium carbonate produced according to claim 2.

8. A method according to claim 7, wherein said composition is a polyurethane sealing compound.

9. A method according to claim 8, wherein said composition is a one-component sealing compound.

10. A method according to claim 8, wherein said composition is a two-component sealing compound.

11. A method according to claim 7, wherein said composition is a silicone sealing compound.

12. A method according to claim 11, wherein said composition is a modified silicone sealing compound.

13. A method according to claim 12, wherein said composition is a MS polymer sealing compound.
